(19) United States
(12) Patent Application Publication
(10) Pub. No.: US 2009/0152934 A1
(43) Pub. Date: Jun. 18, 2009

(54) HEATED TRUCK BODY

(76) Inventors: Roelof Devries, Somerset, PA (US); Thomas Pletcher, Markelton, PA (US)

Correspondence Address: KING & SCHICKLI, PLLC, 247 NORTH BROADWAY, LEXINGTON, KY, 40507, US

(21) Appl. No.: 12/335,138

(22) Filed: Dec. 15, 2008

Related U.S. Application Data
(60) Provisional application No. 61/013,420, filed on Dec. 13, 2007.

(51) Int. Cl. B60P 1/00

(52) U.S. Cl. 298/1 H

(57) ABSTRACT

A truck has a cab, a body, an engine, and an exhaust system. The body carries loads during use and each of its panels has an interior fluidly connected to one another. The exhaust system receives exhaust from the engine which flows thru exhaust pipes into a muffler and then into a diverter box. When desired, the diverter box diverts at least a portion of the exhaust air into an air outlet that directs air to the interiors of the panels to heat the body during use. Any remaining portion of the exhaust air, is exhausted directly to ambient air. A circuit controls the flow of exhaust gases to the truck body utilizing a diverter, an actuator for controlling the diverter, and a temperature sensor for controlling the actuator wherein a flow of exhaust gases to the truck body is shut off when said temperature sensor senses an exhaust gas temperature above a predetermined level. Alternatively, a signal indicating the start of a regeneration cycle of a diesel particulate filter can be used to control the actuator.

This application claims the benefit of U.S. Provisional Patent Application Ser. No. 61/013,420, the disclosure of which is incorporated herein by reference.

### TECHNICAL FIELD

The present invention relates to controlled heating of truck bodies, especially dump truck bodies, to maintain high temperatures of hot loads, especially asphalt, and/or to prevent any loads from freezing or sticking during cold weather hauling.

### BACKGROUND OF THE INVENTION

The art of hauling and dumping loads with trucks has long been known. Unfortunately, so too has the problem of loads freezing and sticking during cold weather hauling. Thus, a variety of mechanisms have been introduced in the prior art to alleviate or lessen the problem. Yet all solutions can now be improved upon for one reason or another.

For example, many prior art references teach the diversion or siphoning of engine exhaust gasses to the truck body for heating a load therein. Specifically, U.S. Pat. No. 1,942,207 (R. Ferwerda) teaches replacing a muffler of an exhaust pipe with conduits and diverting exhaust gasses into an underside of a truck body or cargo bed. In U.S. Pat. No. 2,275,622 (L. E. Gatien), a trailer body becomes heated by siphoning a portion of the exhaust gasses from an exhaust pipe. In U.S. Pat. No. 3,472,548 (S. Comisac), a dump truck body becomes heated by diverting exhaust gasses from an exhaust pipe into exhaust outlets of a truck body floor. Similarly, U.S. Pat. No. 3,499,678 (M. M. Richler) teaches diversion of exhaust gas into longitudinal duct members that extend underneath a floor of a truck body. More recently, U.S. Pat. No. 5,797,656 (Kauk et al.) teaches diversion of exhaust gasses by means of a controllable diverter member positioned in first and second blocking position wherein gas becomes directed to either the truck bed or the truck muffler, but not both.

A recent change in the law concerning the allowable emissions of unburned particulates, or soot, from diesel engines has given rise to new technology for removing unburned particulates from the exhaust stream of such trucks. Most new trucks have a diesel particulate filter, or DPF, to accomplish this task. As the DPF accumulates soot, it eventually becomes clogged. Thus, most DPF's are equipped with a means of burning the soot in a process called regeneration. During the regeneration process, exhaust temperatures can be elevated considerably higher than is typical during normal operation. In these instances, the higher temperatures can damage the body by burning paint, weakening or melting aluminum, or igniting the load when the exhaust stream is diverted to the dump body during regeneration. Accordingly, a need exists for simply and economically controlling the flow of the exhaust stream, into the truck body to avoid damage to the body caused by high temperatures associated with the DPF and/or operator error and to alert the driver of high temperature situations.

### SUMMARY OF THE INVENTION

The above-mentioned and other problems become solved by applying the principles and teachings associated with the hereinafter described heated truck body, especially a dump truck body.

In one embodiment, the truck has a cab, a body, an engine, and an exhaust system. The body, defined by a floor and front, rear and sidewall panels, carries loads during use and each of the panels has an interior fluidly connected to one another. The exhaust system receives exhaust from the engine which flows thru exhaust pipes into a muffler as is known in the art and then into a diverter box. When desired, the diverter box diverts at least a portion of the exhaust air into an air outlet that directs air to the interiors of the panels to heat the body during use. Any remaining portion of the exhaust air is exhausted directly to ambient air.

Preferably, the air outlet fluidly connects to the interior of the front panel wherein air is directed in generally opposite directions therein. In turn, air flows from the front panel to the interiors of the sidewall panels and is exhausted to ambient air near the rear of the side panels. More preferably, the air flows through the interior of the panels in a vicinity near the floor and, occurs for substantially the entirety of the length of the front and sidewall panels. In other embodiments, air is introduced into the body at any location around the body panels and travels around the panels. A temperature sensor may mount to the body along one or more of the panels to provide an indication of air temperature in the body or the temperature of the body.

In other aspects of the invention, a control panel resides within the cab and monitors exhaust temperatures at the dump body. A control circuit further operates to automatically shut down exhaust flow to the dump body when temperatures are elevated during the regeneration process associated with diesel particulate filters and when the power take-off (PTO) or driveshaft is engaged. The heating system can further be manually turned on and off from the in-cab control panel. The control panel may also include a visual indicator for indicating temperature and/or a power on/off condition. The control panel receives its power from the battery.

Finally, methods for heating a truck are also disclosed. In one embodiment, the method recites providing a control circuit for selectively directing heated air from an exhaust system into an interior of a truck body panel; flowing the air from the interior of the panel to the interior of the remaining panels; and exhausting the air along a rear portion of the side panels.

These and other embodiments, aspects, advantages and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification illustrate several aspects of the present invention and together with the description serve to explain certain principles of the invention. In the drawings:

FIG. 1 is a side diagrammatic view in accordance with the teachings of the present invention of a heated truck body;

FIG. 2 is a perspective view in accordance with the teachings of the present invention of a truck body with a heated air flow diagram superimposed thereon;

FIG. 3 is a partial cross sectional view in accordance with the teachings of the present invention of a truck body with a heated air flow diagram superimposed thereon;

FIG. 4 is a partial view in accordance with the teachings of the present invention of a diverter box positioned along an exhaust system in a closed position directing engine exhaust through an exhaust pipe;

FIG. 5 is a partial view in accordance with the teachings of the present invention of a diverter box positioned in an exhaust pipe in an open position directing at least a portion of the engine exhaust through a body for heating the body;

FIG. 6 is a schematic diagram in accordance with the teachings of the present invention of an electrical circuit for controlling the operation of the diverter and the diversion of engine exhaust between an exhaust pipe and a body; and

FIG. 7 is a partial view in accordance with the teachings of the present invention of a diverter box positioned adjacent an exhaust pipe in a closed position directing engine exhaust through an exhaust pipe and, in phantom, an open position directing engine exhaust at least partially through a body for heating the body.

Reference will now be made in detail to the present preferred embodiment of the invention, an example of which is illustrated in the accompanying drawings.

### DETAILED DESCRIPTION OF THE PREFERRED EMBODIMENT

In the following detailed description of the preferred embodiments, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized and that process or other changes may be made without departing from the scope of the present invention. The following detailed, description is, therefore, not to be taken in a limiting sense and the scope of the present invention is defined only by the appended claims and their equivalents. In accordance therewith, a simple and economic heated truck body design that heats the dump body and protects the dump body against overheating by monitoring the status of the diesel particulate filter, is hereinafter described.

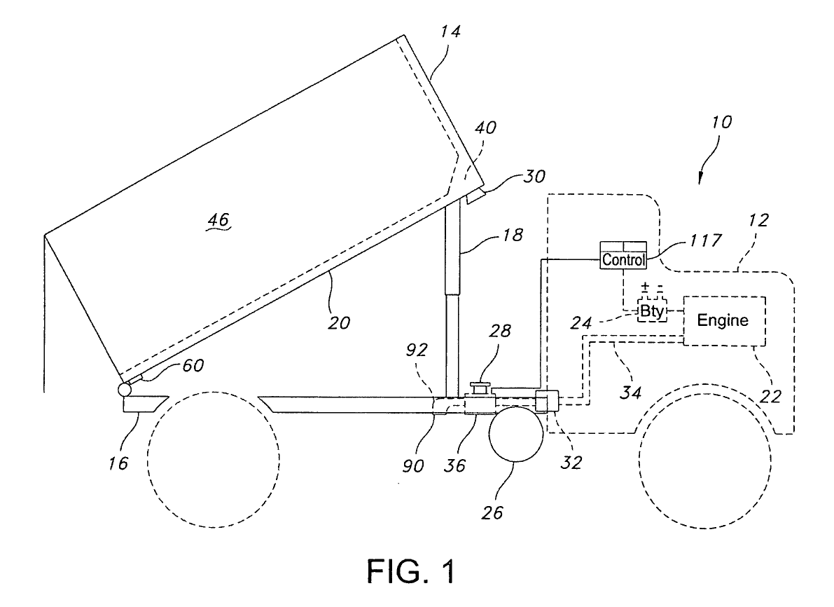

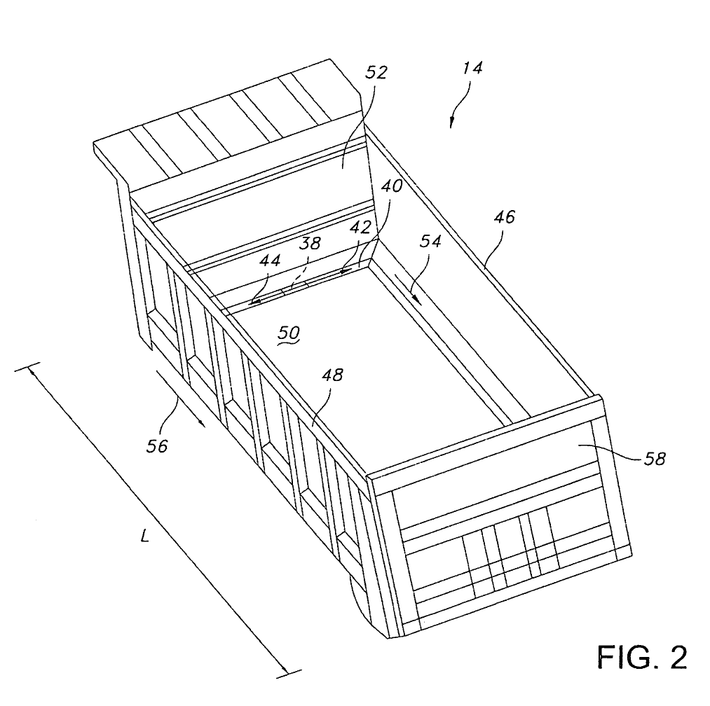

With reference to FIG. 1, a truck 10 generally has a cab 12 and a cargo bed or body 14, especially a dump body, mounted to a common frame or chassis 16. A cylinder 18, preferably hydraulic, telescopically presses between the chassis and an underside 20 of the body to raise or lower the body for dumping operations as is well known in the art. An engine 22, connected to both a battery 24 and a fuel tank 26, supplies the requisite power for operation of the truck and its components, i.e., the dump body, and is also well known in the art. An electric starter, not shown, typically resides within the cab 12 and electrically interconnects the battery 24 with the engine 22 to allow an operator on/off engine control.

In accordance with the present invention, an air outlet 28 mates with a corresponding air inlet 30 on the underside 20 of the dump body 14 and creates a fluid coupling for air, preferably heated exhaust air, to exit the engine 22 and diesel particulate filter 32 and flow into and enter the body 14 whenever the body mates with the chassis 16. In this manner, the heated truck body 14 can obtain increased temperatures relative to unheated truck bodies.

Exhaust air is directed through and around the dump body 14 in any configuration as known in the art. In the present preferred embodiment, the air flow pattern for heating a truck body 14 includes exhaust air leaving the engine 22 along exhaust pipe 34 and through diesel particulate filter 32. A muffler (not shown) may be positioned between the engine 22 and the diverter box 36 as is known in the art. When directed into the dump body 14 through diverter box 36, the air travels through coupled air outlet 28 and air inlet 30, and opening 38 into a radius or air flow conduit 40. The air flow conduit 40 in this embodiment is generally triangular in shape and is formed by the floor 50, front panel 52, and a radius wall 62. In heated bodies and unheated bodies alike, radius walls are commonly utilized to reduce hang up of material during dumping. Once in the conduit 40, the air flow naturally divides and flows in generally opposite directions shown by arrows 42, 44 toward sidewall panels 46 and 48.

In one embodiment, the air travels along a surface of the floor 50 or within an interior of the floor as will be later described. In other embodiments, the air travels underneath the body in air flow conduits within the chassis. In any embodiment, once the air reaches air flow conduit 40 positioned along the front panel 52, it naturally divides in some ratio and travels in directions 42, 44 essentially opposite one another. Thereafter, the air reaches the sidewall panels 46 and 48 and turns in directions shown by arrows 54 and 56, respectively, generally toward a rear panel 58. Finally, when the air reaches a rearward portion of the sidewall panels 46 and 48, the air is exhausted into ambient air through openings 60 positioned on either side of the dump body 14. A representative opening 60 is shown in FIG. 1 adjacent the rearward portion of sidewall panel 46.

Appreciating that if the front and sidewall panels join one another at nearly perpendicular corners, the air flow path can become tortuous. The dump body may include various additional gradual-turn connectors or non-perpendicular corner designs to minimize any adverse affects.

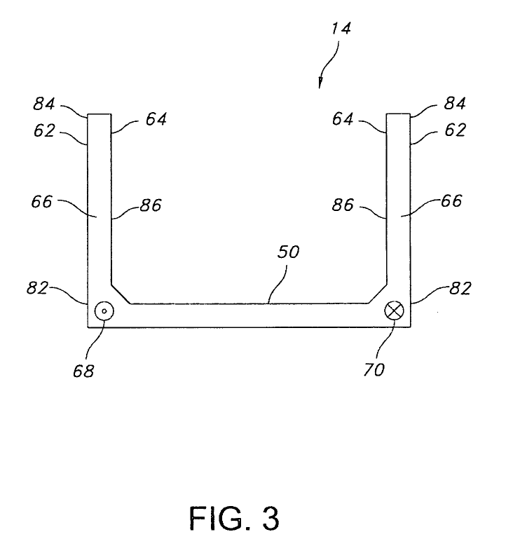

With reference to FIG. 3, skilled artisans will appreciate that many industry dump body floors and/or front, rear and sidewall panels actually comprise multiple wall designs such as substantially parallel interior and exterior walls 62, 64 defining an interior 66 having slats (not shown) or other structural support members therein. As such, one air-flow embodiment of the present invention takes advantage of such panel design and causes airflow throughout the truck body 14 to occur within the interiors 66 of the front, sidewall and/or rear panels. As shown, air flows in a first-direction 68 (indicated as an arrow tip pointed out of the paper) within an interior of a first sidewall and flows in a second direction 70 (indicated as an arrow end directed into the paper) within an interior of a second sidewall and both occur along a lower portion 82 of the panel in the vicinity of the floor 50. Alternatively, air flow occurs within the panels along upper portions 84 or mid-portions 86 of the panels in addition to or as a supplement to air flow occurring near the lower portions 82 of the panels.

As briefly noted above and shown in FIG. 1, a diesel particulate filter 32 for removing unburned particulates from the exhaust stream is positioned in the exhaust stream between the engine 22 and an exhaust pipe or outlet 38. Diesel particulate filters are known in the art for removing diesel particulate matter or soot from the exhaust gas of a diesel engine. Although some filters are single use, i.e., disposable, others are designed to burn off the accumulated particulate, either through the use of a catalyst, or through an active technology, such as a fuel burner which heats the filter to soot combustion temperatures, through engine modifications (e.g., the engine is set to run a certain specific way when the filter load reaches a pre-determined level, either to heat the exhaust gases, or to produce high amounts of NO₂, which will oxidize the particulates at relatively low temperatures), or through other methods. These processes are commonly referred to as regeneration. During the regeneration process, exhaust temperatures can be elevated considerably higher than temperatures during normal operation.

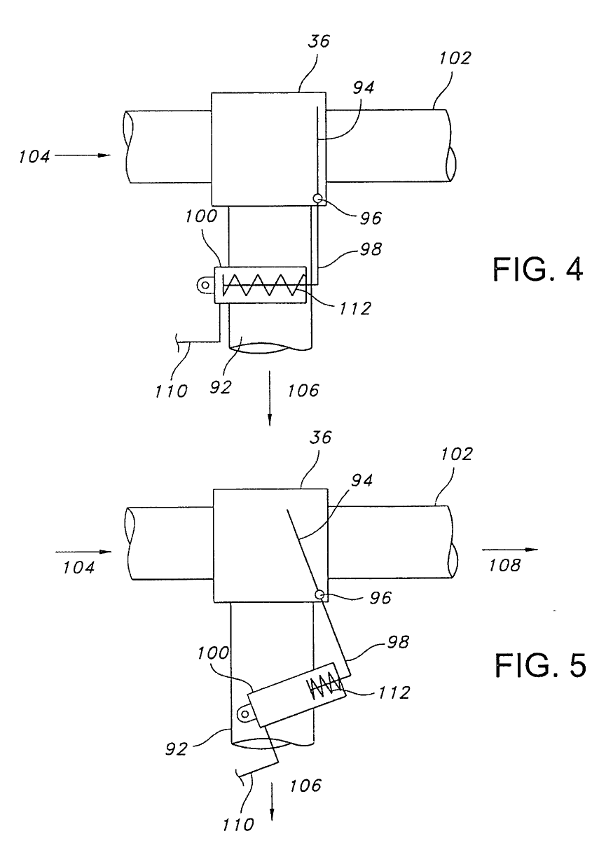

In accordance with the present invention, a diverter box 36 is positioned in or adjacent to an exhaust pipe 92 of the truck 10 as shown in FIG. 4. Inside the diverter box 36 is a diverter 94, or flapper, that pivots about a shaft 96, and is attached to an actuating arm 98. The actuating arm or lever 98 is moved in one direction or the other by an air cylinder 100 or the like. In FIG. 4, the diverter 94 is shown in a closed position, covering an outlet pipe 102 to the body 14 so that all the exhaust gases generated by the engine 22 (shown by directional arrow 104) are directed through the exhaust pipe 92 (shown by directional arrow 106) to exhaust outlet 90.

In FIG. 5, the diverter 94 is shown in an open position, at least partially uncovering, the outlet pipe 102 to the body 14, so that exhaust gases generated by the engine 22 (shown by directional arrow 104) are directed through both the exhaust pipe 92 (shown by directional arrow 106) and the outlet pipe 102 (shown by directional arrow 108) to the body 14. The air cylinder 100 in the present preferred embodiment is single acting, with a spring return. In other words, when air is supplied through air line 110, the air cylinder 100 is extended to open the diverter 94. This motion also compresses a spring 112. When the air supply is removed, and air is allowed to escape from the air cylinder 100, the spring 112 forces the air cylinder and diverter 94 to the closed position as shown in FIG. 4. This is a fail safe arrangement, meaning that if something goes wrong with the controls, including a leaking air line for example, the diverter 94 will automatically return to the safe, or closed position in order to avoid damaging the body.

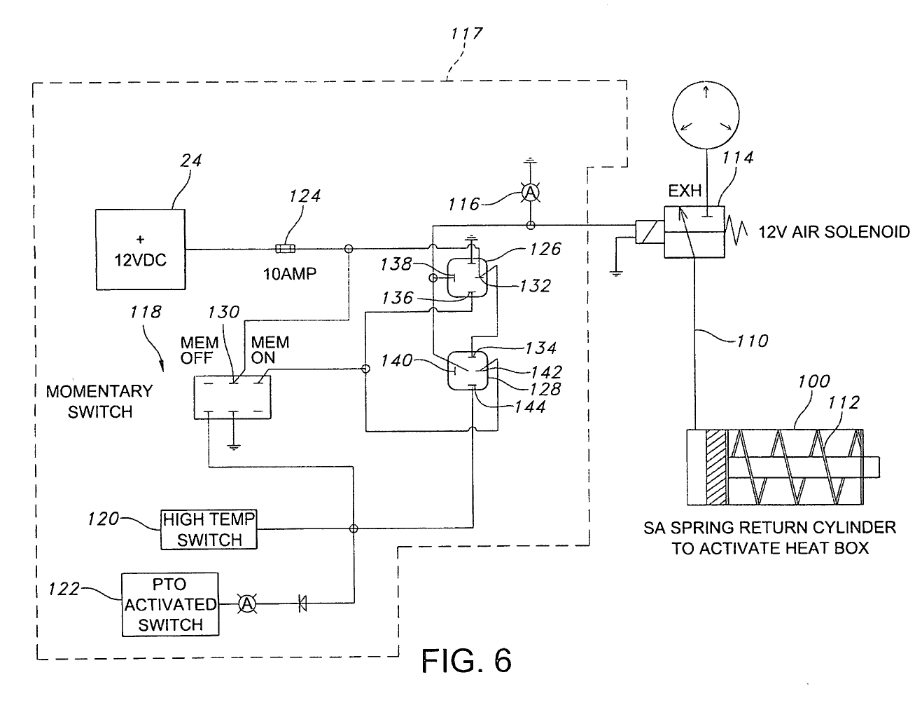

As shown in the schematic diagram of FIG. 6, the air cylinder 100 is controlled by an air solenoid valve 114. When the solenoid on this air solenoid valve 114 is electrically activated, the valve supplies air to the air cylinder 100. The air solenoid valve 114 is also designed to operate in a fail safe manner because it exhausts air if there is a loss of current to the solenoid valve 114. An indicator light 116 is energized by the same electrical control circuit 117 as the air solenoid valve 114. This indicator light 116 is in view of the operator in the cab, and is lit any time that the diverter 94 is open, sending heated exhaust gases to the body 14.

The electrical control circuit or controller 17 is likewise positioned in the cab and is designed to close the diverter 94 under three circumstances: (1) when the operator manually activates a control/off switch 118; (2) when the power take-off or PTO is engaged which occurs any time the body 14 is being raised for dumping; and (3) whenever a temperature switch 120 is engaged. This temperature switch 120 may operate directly or through the controller 117, and may be set at a single temperature or be adjustable. The electrical circuit is also designed to require the operator to manually re-start the flow of exhaust to the body 14 after any time the diverter box 36 is closed.

The electrical circuit shown in FIG. 6 consists of a PTO switch 122, temperature switch 120, control switch 118, battery or power supply 24, fuse 124, and two relays 126 and 128. The power supply may be provided by the battery 24 or elsewhere within the truck's electrical circuit. In operation, power is always supplied to one of the connections 130 on the control switch 118, to the high-voltage input 132 of relay 126, and to the low-voltage, or coil, input 134 of relay 128. When the momentary on switch 118 is activated, power is also supplied to the low-voltage, or coil, input 136 of relay 126. This causes a connection to be completed on the high side of relay 126, supplying power at Normally Open output 138. This supplies power to the air solenoid valve 114, and also to the Normally Closed output 140 of relay 128. Relay 128 is not activated at this time, so the Normally Closed output 140 is connected to the high side input 142 of relay 128. This supplies power to the low-side input 136 of relay 126.

When the momentary on switch 118 is released, power supply to the air solenoid valve 114 is maintained through the path: Power supply 24 to fuse 124 to high side input 132 of relay 126 to high side output 138 of relay 126 to Normally Closed output 140 of relay 128 to high side input 142 of relay 128 to low side input 136 of relay 126 to ground. This circuit is broken by activating relay 128, which is done by completing a ground to the coil side 144. This completion of ground can be done by any one of the three switches: PTO switch 122, Temperature switch 120, or control switch 118. Therefore and in accordance with the present preferred embodiment, if the diverter 94 is closed due to the temperature switch 120 sensing an elevated exhaust gas temperature for example, as the temperature goes down, the diverter does not automatically open, but needs the operator to re-activate the control switch 118. In an alternative embodiment, the temperature switch 120 could be replaced by a signal from the truck that controls the start of regeneration of the diesel particulate filter.

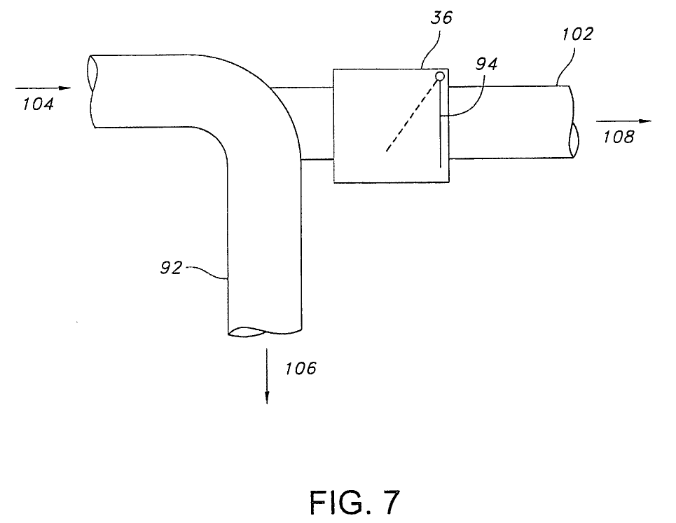

With reference to FIG. 7, skilled artisans will appreciate that the diverter box 36 can be positioned in many varying positions along the exhaust system and/or adjacent the exhaust system. For example, the diverter box 36 could be positioned in the outlet pipe 102 between the exhaust system and the truck body 14. In this embodiment, exhaust gases generated by the engine 22 (shown by directional arrow 104) are directed through the exhaust pipe 92 (shown by directional arrow 106) when the diverter 94 is in a closed position as shown. When the diverter 94 is in an open position (shown in phantom), exhaust gases generated by the engine 22 (shown by directional arrow 104) are directed through both the exhaust pipe 92 (shown by directional arrow 106) and the outlet pipe 102 (shown by directional arrow 108) to the body 14. Again, the diverter 94 and air cylinder 100 are utilized in a fail safe arrangement that will automatically return to the safe, or closed position in order to avoid damaging the body in unsafe conditions cause by the regeneration process.

Lastly, the invention contemplates interchangeability with other types of truck bodies other than the dump body shown. For example, the teachings herein apply equally to stationary-bed trucks, cement mixers, cargo trailers or any other trucks that haul loads requiring heat.

The foregoing description is presented for purposes of illustration and description of the various aspects of the invention. The descriptions are not intended to be exhaustive or to limit the invention to the precise form disclosed. The embodiments described above were chosen to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A truck having a diesel engine and a diesel particulate filter to remove diesel particulate matter or soot from the diesel engine exhaust comprising:
a dump body mounted to a chassis for carrying loads and configured to receive a flow of filtered exhaust gas from the diesel engine;
a diverter for selectively diverting at least a portion of the filtered exhaust gas to said dump body to raise the temperature of said dump body and prevent the loads carried therein from freezing to said dump body; and
an actuator for controlling said diverter, said actuator responsive to a signal from a control circuit indicating the initiation of a regeneration cycle associated with the diesel particulate filter;
wherein the flow of filtered exhaust gas diverted to the truck body is reduced.

2. The truck of claim 1 wherein said dump body includes a floor, front and sidewall panels, and radius walls forming a conduit for receiving the flow of filtered exhaust gas from the diesel engine.

3. The truck of claim 2, wherein the flow of filtered exhaust gas from the diesel engine enters said conduit along the front panel and naturally divides and flows in generally opposite directions toward said sidewall panels.

4. The truck of claim 3, wherein the naturally divided flows of filtered exhaust gas from the diesel engine exhausts to ambient air near a rearward portion of said sidewall panels.

5. The truck of claim 1, wherein said actuator is an air cylinder having an actuating arm attached to said diverter for moving said diverter between open, partially open and closed positions.

6. The truck of claim 5, wherein said air cylinder is single acting with a spring return which forces said diverter to a closed position when air pressure is removed from said air cylinder in a fail safe manner.

7. The truck of claim 1, wherein the flow of filtered exhaust gas diverted to the truck body is completely stopped when a temperature sensor indicates a temperature above a predetermined level.

8. The truck of claim 7, wherein the temperature is either the temperature of the filtered exhaust gas from the diesel engine or the temperature of the dump body.

9. The truck of claim 1, wherein said diverter is positioned such that the filtered exhaust gas flows thru said diverter and is either at least partially diverted to said dump body or allowed to flow to ambient air thru an exhaust outlet.

10. A truck having a diesel engine and a diesel particulate filter to remove diesel particulate matter or soot from the diesel engine exhaust comprising:
a dump body mounted to a chassis for carrying loads and configured to receive a flow of filtered exhaust gas from the diesel engine;
a diverter for selectively diverting at least a portion of the filtered exhaust gas to said dump body to raise the temperature of said dump body and prevent the loads carried therein from freezing to said dump body;
an actuator for controlling said diverter, said actuator responsive to a signal from a control circuit indicating an elevated temperature of the filtered exhaust gas caused by a regeneration cycle associated with the diesel particulate filter;
wherein the flow of filtered exhaust gas diverted to the truck body is reduced.

11. The truck of claim 10, wherein said dump body includes a floor, front and sidewall panels, and radius walls forming a conduit for receiving the flow of filtered exhaust gas from the diesel engine.

12. The truck of claim 11, wherein the flow of filtered exhaust gas from the diesel engine enters said conduit along the front panel and naturally divides and flows in generally opposite directions toward said sidewall panels.

13. The truck of claim 12, wherein the naturally divided flows of filtered exhaust gas from the diesel engine exhausts to ambient air near a rearward portion of said sidewall panels.

14. The truck of claim 10, wherein said actuator is an air cylinder having an actuating arm attached to said diverter for moving said diverter between open, partially open and closed positions.

15. The truck of claim 14, wherein said air cylinder is single acting with a spring return which forces said diverter to a closed position when air pressure is removed from said air cylinder in a fail safe manner.
